(19) United States
(12) Patent Application Publication
(10) Pub. No.: US 2007/0042709 A1
(43) Pub. Date: Feb. 22, 2007

(54) Audio device having integrated satellite receiver and FM transmitter functionalities

(75) Inventors: Michael Krieger, Miami Beach, FL (US); Kevin Ellsworth, Alva, FL (US)

Correspondence Address: VECTOR PRODUCTS, INC.;ROBERT POWELL, P.O. BOX 34385, c/o VENABLE LLP, WASHINGTON, DC, 20043-9998, US

(73) Assignee: Vector Products, Inc., Ft. Lauderdale, FL (US)

(21) Appl. No.: 11/406,392

(22) Filed: Apr. 19, 2006

Related U.S. Application Data
(60) Provisional application No. 60/672,505, filed on Apr. 19, 2005.

(51) Int. Cl. H04H 1/00

(52) U.S. Cl. 455/3.02

(57) ABSTRACT

An audio device comprises a satellite receiver for receiving an audio signal via a receive antenna. A transmitter transmits the audio signal to an external receiver via a transmit antenna for remote rendering of the audio signal. A cup-shaped housing encloses the satellite receiver and the transmitter. The cup-shaped housing is configured for insertion into a cup holder to securely position the audio device inside a vehicle

### FIELD OF THE INVENTION

The present invention relates to communications systems. More specifically, the present invention relates to an audio device that communicates using a satellite K. audio receiver service (SDARS) receiver and an FM transmitter.

### BACKGROUND

It has been said that satellite radio has the capability to revolutionize the radio industry, in the same manner that cable and satellite television revolutionized the television industry. This is because satellite radio broadcast can improve terrestrial radio by offering a better audio quality, greater coverage and fewer commercials. For example, satellite radio broadcasters, such as Sirius and XM, have been providing digital quality radio services covering the entire continental United States. These services offer many channels containing music, news, sports, talk and data content.

Various types of satellite SDARS receivers are currently marketed by satellite broadcasters themselves as well as third parties. Exemplary receivers are configured to be ‘plugged’ into optional car kits, home kits or boom boxes to operate in cars, or as stand alone devices, at homes or as portable devices that can be carried around. One company, XAST Communications, offers a radio receiver called Stream Jockey, which is a palm-sized unit that could be fitted into a universal docking station in the car or in the home. The device includes features such as integrated headphone, volume controls and screen display. Stream Jockey can be used as a stand-alone receiver with a stereo system or it can be wirelessly connected to a vehicle's FM radio receiver.

For receiving satellite signals in a vehicle, radio frequency (RF) signals must be transferred from outside to inside the vehicle. For example, for receiving satellite RF signals, an antenna can be attached to an automobile window using an adhesive, and RF signals can be transferred to an apparatus on the inside of the window using capacitive coupling, slot coupling or aperture coupling. Typically, as is known in the art, the antenna system consists of a transmission line, a coupling device such as a capacitive plate, a slot, or an aperture, a matching circuit between the transmission line and the coupling device, and the antenna itself. Examples of prior vehicle antennas are disclosed in U.S. Pat. No. 5,898,408 to Du, U.S. Pat. No. 4,882,592 to Studer, Jr. et al., U.S. Pat. No. 5,099,251 to Fisher, U.S. Pat. No. 4,799,098 to Blaese, U.S. Pat. No. 4,266,227 to Blaese, U.S. Pat. No. 4,109,251 to MacDougall, U.S. Pat. No. 5,850,199 to Wan et al., and U.S. Pat. No. 5,898,407 to Paulus et al.

U.S. Pat. No. 6,421,020 discloses an apparatus, system and method for providing audio broadcast signals received from a satellite to a satellite radio receiver. A window clip having an integral transmission line is mounted on the edge of a vehicle window. The interior end of the transmission line is connected to the satellite radio receiver. The exterior portion of the clip, and the exterior portion of the integrated transmission line, is coupled to an antenna. The apparatus includes an antenna system used to receive satellite SDARS and transfer the signal to a satellite radio receiver inside the vehicle. The antenna is an omnidirectional antenna having circular polarization and a frequency range of about 2.3 GHz to about 2.7 GHz, also known as the S-band.

It is also known to integrate an FM transmitter into an audio device to allow audio from an external or internal source (e.g., MP3, CD player, etc.) to be heard remotely at an external radio receiver in the vehicle. For example, the Stream Jockey satellite receiver includes an internal FM transmitter with an internal antenna that radiates an audio modulated FM signal for remote rendering of satellite broadcast audio at the external radio receiver. The received signal is demodulated at the receiver, which is tuned to the FM frequency of the transmitter, to play the audio signal via vehicle speakers.

Another known audio device used in a car has an integrated FM transmitter, an MP3 player and a USB port interface that is used for attaching an external USB storage device. The external USB storage device stores MP3 audio files that could be accessed by the MP3 player, which applies its output to the FM transmitter for remote rendering at the car radio receiver.

Most recent vehicle models include a cup holder with support brackets that mount inside the vehicle or at the front of the passenger compartment. As disclosed in U.S. Pat. No. 6,511,031, it is known to provide a removable docking station disposed on a coffee mug or liquid container for increasing surface stability. U.S. Pat. No. 6,778,813 discloses an audio system/cup assembly having a cup for holding a beverage; a removable audio system base; and a removable adaptor base for enabling the cup to be placed in a vehicle cup holder. U.S. Pat. No. 6,189,755 discloses a combination beverage and cellular phone holder adapted for insertion into an existing vehicle beverage holder to firmly position the cellular phone within the vehicle in a convenient and accessible position. U.S. Pat. No. 6,253,982 discloses an automobile CD player holder for releasably securing a portable CD player within a motor vehicle equipped with a center console having a cup holder.

With the ever increasing availability of functionalities, there exists a continuing need to improve functionalities and operation of audio devices that can be used inside vehicles.

### SUMMARY OF THE INVENTION

Briefly, according to the present invention, an audio device comprises a satellite receiver for receiving an audio signal via a receive antenna. A transmitter transmits the audio signal to an external receiver via a transmit antenna for remote rendering of the audio signal. A cup-shaped housing encloses the satellite receiver and the transmitter. The cup-shaped housing is configured for insertion into a cup holder to securely position the audio device inside a vehicle.

According to some of the more detailed features of the invention, the audio device includes a remote antennae housing that encloses the satellite receive and transmitter antennae. Also, power circuitry are disposed within the cup-shaped housing for powering the audio device. The audio device includes a resource device for rendering a media signal, such as MP3 player audio signal. Under this arrangement a port interface is used for exchanging data with the resource device.

### BRIEF DESCRIPTION OF THE DRAWINGS

FIG. 1 shows an exemplary audio device 100 according to one embodiment of the present invention;

FIG. 2 is a block diagram of the audio device 100 of the present invention; and

FIG. 3 shows various functional block diagrams of the audio device of the present invention.

### DESCRIPTION OF THE PRESENT INVENTION

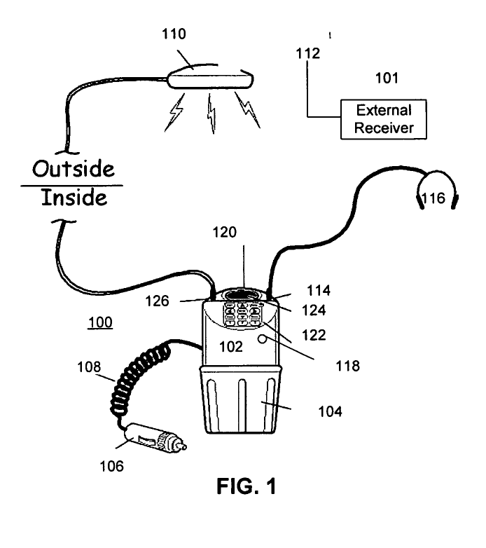

FIG. 1 shows an exemplary audio device 100 according to one embodiment of the present invention. In this embodiment, the audio device 100 comprises a portable audio device that can be securely positioned inside a vehicle for reception of satellite broadcasts audio signals and for playing the received audio signals on an external radio receiver 101, e.g., an FM radio receiver in a vehicle (not shown). As described further in detail, the audio device 100 also integrates a number of other functionalities into a single device.

As shown, the audio device 100 includes a cylindrical housing 102 having an integrated cup-shaped base holder 104 adapted for insertion into a cup holder inside the vehicle. When inserted into the cup holder of the vehicle, the cup-shaped design of the base holder 104 provides the stability under various operating conditions, including extreme road conditions. At the same time, the audio device 100 provides portability by being removable from the cup-holder for use outside the vehicle. For example, the cup-shaped housing design of the invention allows the audio device 100 to be carried inside a home or office and set on a counter with its display and control buttons easily accessible. Existing satellite radio receivers such as Stream Jockey, however, come with a dock that the user can attach to the car dashboard with an adhesive. This design is unsuitable for extreme driving conditions such as sharp turns or heavy breaking. Also, over time, the adhesive would wear, causing the dock to become useless. In addition, when the dock is stuck to the dash of the vehicle, it cannot be used when the receiver is brought into the home or office. Thus, the receiver must be carried inside alone and can only lay flat on a counter, likely requiring the user to pick it up in order to look at the digital display and adjust the settings. The cup-shape housing design of the present invention makes the audio device 100 a portable unit that can be easily inserted and removed from a cup holder and provide convenient access for interfacing with the device.

According to one embodiment, the audio device 100 can be powered inside the vehicle by means of a cigarette lighter adapter (CLA) socket or it can be powered outside of the vehicle by means of internal battery power. As shown, the cup-shaped housing is coupled to a CLA plug 106 via a coil cord 108 that powers the audio device inside the vehicle. The CLA plug 108 is adapted for insertion into the CLA socket for applying an external DC source, for example, the battery source of the vehicle or any other type of suitably generated external source that allow powering various functionalities of the audio device according to the present invention. As shown, the CLA plug 106 includes a center protruding pin that upon insertion couples to a corresponding center contact of the external socket (not shown) to electrically connect with the positive terminal of the external DC source.

In this exemplary embodiment, the cup-shaped housing 102 encloses the circuitry that provide the integrated functionalities of the present invention. Among other things, the cup-shaped housing 102 encloses power conversion circuitry that converts the external DC voltage to a sufficient level for operating the audio device 100. In one embodiment, the cup-shaped housing 102 includes a power compartment for batteries that power the audio device when the audio device is not powered by the CLA plug 106, for example when the audio device is operated outside of the car in the house or office.

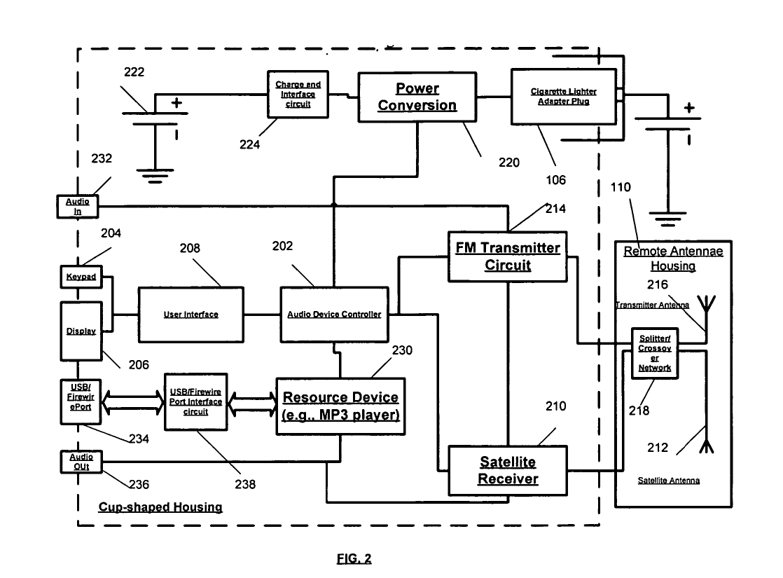

The audio device 100 also includes a satellite radio receiver (shown in FIG. 2) for receiving broadcast audio signals and an FM transmitter (shown in FIG. 2) for transmitting the received audio signals, e.g., music, over a selected frequency for remote rending of the audio signal at an external radio receiver. The external radio receiver 101 is tuned to the transmit frequency of the FM transmitter to remotely render the broadcast satellite audio transmitted from the audio device 100. The housing 102 encloses the circuitry that receive and demodulate the satellite broadcast audio from a satellite service provider, such as Sirrus or XM. The housing 102 also encloses circuitry that modulate a carrier signal with the demodulated satellite broadcast audio for transmission to the external radio receiver 101.

A remote antennae housing 110 encloses FM transmitter and satellite receiver antennae. The remote antennae housing 110 is coupled to the cup-shaped housing 102 of the audio device via a wiring case that includes suitable means for coupling the satellite and FM antennae to the satellite radio receiver and FM transmitter, respectively. In one embodiment, a multi-port connector 126 is used to couple the antennae of the remote antenna housing to the cup-shaped housing of the audio device via a cable/wire casing. Under this arrangement, the remote antennae housing 110 receives satellite audio broadcast signals and transmits modulated FM signal to the external radio receiver 101. Existing satellite radio receivers such as Stream Jockey contain an FM transmitter and antenna that are internal to the unit itself and have a remote satellite antenna external to the unit that is connected by wire to the unit. The satellite receiver antenna is typically meant to be placed on the roof of the user's vehicle. The advantage of the remote antenna housing 110 of the audio device 100 of the present invention is that the FM transmitter antenna can be positioned more closely to the FM receive antenna 112 of the external radio 101 either inside or outside a car. The remote antenna housing 110 can be mounted on a surface in a variety of ways. In one embodiment, the remote antenna housing 110 is mounted on a metallic surface, e.g., roof of the vehicle, via a magnetic mounting mechanism. The interface for radio frequency coupling between inside and outside of the vehicle can be via well-known arrangements, such as via the car window glass.

Instead of rendering the broadcast satellite audio remotely via the FM transmitter, the audio device 100 can play the broadcast audio locally via an audio output port 111 that is used for attaching a speaker headphone 116. Moreover, the audio device 100 can include an audio input port 118 that receives audio from an external source, e.g., a CD player, for playing the external audio remotely via the FM transmitter. In this way, the external audio can be applied to the FM transmitter via the input port 118 for wireless transmission to the external radio receiver.

According to another embodiment, the audio devices also provides port interface functionalities for interfacing with on or more external devices via such port interfaces 120 as USB or Firewire. The USB or Firewire port interfaces can be used to exchange data with one or more resource devices within the audio device, such as a media player, MP3 decoder, etc.. The USB port interface of the audio device can support USB Host or Device controllers, storage devices as well as audio, imaging, multi-media, or video resource devices. For example, the user can use an external memory storage device to play music through the audio device or watch a video or display images. Another feature of the invention allows for recording satellite radio broadcasts onto a memory storage device through the USB/slot port. The audio device 100 of the present invention may also include internal memory storage to store music received through the USB/Firewire port or through the satellite receiver. The port interface 120 can also be used to supply charge energy or power for recharging audio device batteries, as described later in detail.

The audio accessory device 100 further includes a display 124 and keypad 122 for interfacing with the functionalities of the audio device. The audio port can be used for attaching an external speaker to the audio device, where the keypad and display provide the interface and controls for rendering the audio to the user.

Referring to FIG. 2, a block diagram of the audio device 100 of the present invention is shown. Preferably, the audio device 100 run under the control of a device controller 202 that is responsible for overall operation of the device. Under the control of the device controller 202, a key pad 204 and display 206 provide user interface with the device via a user interface circuit 208. The audio device 100 includes a satellite radio receiver 210 that is coupled to a remote satellite antenna 212 for receiving broadcast audio signals. The satellite radio receiver 210 demodulates the broadcast audio signal received via the satellite antenna 212 and applies the demodulated audio as an input to an FM transmitter 214 for transmission on a selected carrier frequency. Using the keypad and display 204, 206, a desired frequency may be selected for FM transmissions. A remote FM transmitter antenna 216 radiates the modulated FM signals to the external radio receiver 101 (shown in FIG. 1). The remote position of the transmit antenna allows the radiation to be more efficiently received by the antenna of the external radio receiver.

As shown, the satellite receiver and FM transmitter antennae are enclosed in the remote antennae housing 110. In one embodiment, the remote antennae housing 110 has a magnet that fixes it on a metallic surface. Depending on the application, other mounting mechanism, e.g., adhesives or fasteners, etc., may be used for mounting the remote antennae housing on any surface.

As stated above, a multi-port connector is used to couple the antennae of the remote antenna housing to the cup-shaped housing of the audio device via a cable/wire casing. In another embodiment, the remote antennae housing could be coupled to the cup-shaped housing using a single cable that carries both satellite and FM radio frequency signals. Under this arrangement, the remote antennae housing includes a splitter a suitable crossover network 218 that applies the received satellite RF signal to the satellite receiver 210 and applies the FM RF signal to the FM antenna 216. In still another embodiment of the invention, the FM and satellite antennae 212, 216 could be integrated into a single unit and couple to the cup-shaped housing via a single cable. The cable can also be used to convey control signals between the remote antenna housing 110 and the circuitry disposed in the cup-shaped housing 102 of the audio device 100. The enclosed circuitry in the housing can be powered through power conversion circuitry either via the CLA plug 106 attached to the housing or via one or more batteries 220 enclosed within the power compartment of the cup-shaped housing 102. The batteries 222 may comprise rechargeable batteries that are charged via a charge circuit 224.

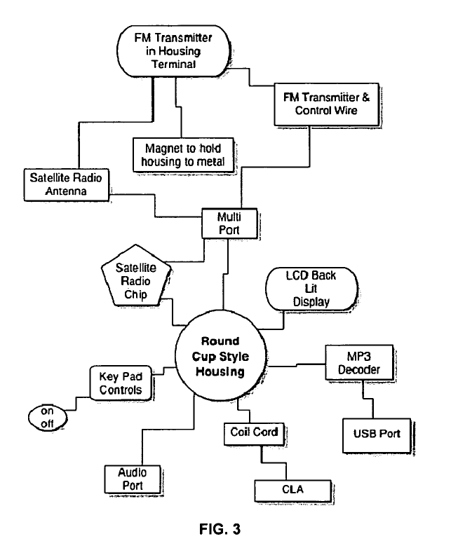

As stated above, the FM transmitter 214 modulates applied internal or external audio signals on a carrier frequency wherein the generated radio frequency signal is radiated via the FM transmit antenna in the remote antennae housing to the external radio receiver. As stated above, the internal audio can be generated by the satellite radio receiver 210 or a resource device 230 comprising a media player, e.g., MP3 player. The applied audio signal can also be an external audio signal provided, via an audio input port 231, from an external source, e.g., CD player, to the accessory device. An audio output port 236 provides audio to an external source such as a speaker phone. The audio device 100 itself can also include a media player, such as an MP3, video, or image player. Data used by such media player can be exchanged in and out of the audio device via a USB or Firewire port 234 and corresponding interface circuitry 238. Such interface is connected to an external device, e.g., a storage device, via a complementary port interface connector. FIG. 3 discloses various functional block diagrams of the audio device of the present invention.

The invention has been described in detail with respect to referred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. An audio device, comprising:
a satellite receiver for receiving an audio signal via a receive antenna;
a transmitter for transmitting the audio signal to an external receiver via a transmit antenna for remote rendering of the audio signal; and
a cup-shaped housing that encloses the satellite receiver and the transmitter.

2. The audio device of claim 1, further including the receive antenna, the transmit antenna and a remote antennae housing that encloses the receive antennae and the transmit antennae.

3. The audio device of claim 1, further including power circuitry in the cup-shaped housing for powering the audio device.

4. The audio device of claim 1, further including a resource device in the cup-shaped housing for rendering a media signal.

5. The audio device of claim 4, wherein the resource device comprises an MP3 player.

6. The audio device of claim 4, further including a port interface in the cup-shaped housing for exchanging data with the resource device.

7. An audio device, comprising:
a receive antenna;
a transmit antenna;
a satellite receiver for receiving an audio signal via the receive antenna;
a transmitter for transmitting the audio signal to an external receiver via the transmit antenna for remote rendering of the audio signal; and
a remote antennae housing that encloses the receive antennae and the transmit antennae.

8. The audio device of claim 7, further including a cup-shaped housing that encloses the satellite receiver and the transmitter.

9. The audio device of claim 7, further including power circuitry in the cup-shaped housing for powering the audio device.

10. The audio device of claim 7, further including a resource device in the cup-shaped housing for rendering a media signal.

11. The audio device of claim 10, wherein the resource device comprises an MP3 player.

12. The audio device of claim 10, further including a port interface in the cup-shaped housing for exchanging data with the resource device.

13. An audio device, comprising:
a satellite receiver for receiving an audio signal via a receive antenna;
a transmitter for transmitting the audio signal to an external receiver via a transmit antenna for remote rendering of the audio signal;
a resource device for rendering a media signal; and
a port interface for exchanging data with the resource device.

14. The audio device of claim 13, further including a cup-shaped housing that encloses the satellite receiver and the transmitter.

15. The audio device of claim 13, further including the receive antenna, the transmit antenna and a remote antennae housing that encloses the receive antennae and the transmit antennae.

16. The audio device of claim 13, further including power circuitry for powering the audio device.

17. The audio device of claim 13, wherein the resource device comprises an MP3 player.
